(19) United States
(12) Patent Application Publication
(10) Pub. No.: US 2015/0351361 A1
(43) Pub. Date: Dec. 10, 2015

(54) ANIMAL HOUSING UNIT WITH LOWER REAR VENTS

(71) Applicant: Poly Dome Ontario Inc., Grassie (CA)

(72) Inventor: Darren VanBuuren, Grassie (CA)

(21) Appl. No.: 14/609,165

(22) Filed: Jan. 29, 2015

Related U.S. Application Data
(63) Continuation-in-part of application No. 29/492,936, filed on Jun. 4, 2014.

(51) Int. Cl. A01K 1/00

(52) U.S. Cl. CPC A01K 1/0064

(57) ABSTRACT

Selectively closable vents are provided in the lower corners of the rear wall of an animal housing unit, adjacent the corners where the rear wall joins the side wall. The animal housing unit comprises an enclosure formed by a front wall, a rear wall opposed to the front wall, two opposed side walls extending between the front wall and the rear wall, and a roof spanning the walls. The enclosure further comprises a base remote from the roof and adapted to support the enclosure on a surface. A doorway is formed in the front wall, and at least two selectively closable vents are in the rear wall adjacent respective junctions between the rear wall and the side walls. Each of the vents includes at least one vent aperture positioned less than about 24 inches from the base.

### CROSS-REFERENCE TO RELATED APPLICATIONS

This application is a continuation-in-part of U.S. application Ser. No. 29/492,936, filed Jun. 4, 2014, entitled “ANIMAL HOUSING UNIT,” the entirety of which is incorporated herein by reference.

### TECHNICAL FIELD

The present invention relates to animal housing units, and more particularly to ventilation of animal housing units.

### BACKGROUND

It is well known to place livestock, such as cattle or goats, in enclosed individual housing units. Typically these housing units will be formed from plastic, and will include a doorway permitting ingress and egress by the animal and may also include accommodation for feeding and watering the animal. Examples of such housing units are shown and described in U.S. Design Pat. Nos. 363,367, 450,890 and 652,995.

Ventilation of these individual housing units is particularly important, as ammonia build-up in warm weather can sicken the animals. While many livestock housing units are provided with vents, known vent arrangements are of limited effectiveness in promoting air exchange in the lower areas of the housing units opposite the doorways.

### SUMMARY

Selectively closable vents are provided in the lower corners of the rear wall of an animal housing unit, adjacent the corners where the rear wall joins the side wall.

According to one aspect, an animal housing unit comprises an enclosure, the enclosure comprising a front wall, a rear wall opposed to the front wall, two opposed side walls extending between the front wall and the rear wall, and a roof spanning the walls. The enclosure further comprises a base remote from the roof and adapted to support the enclosure on a surface. A doorway is formed in the front wall, and at least two selectively closable vents are in the rear wall adjacent respective junctions between the rear wall and the side walls. Each of the vents includes at least one vent aperture positioned less than about 24 inches from the base. Preferably, each of the vents includes at least one vent aperture positioned between about 6 inches and about 22 inches from the base, more preferably each of the vents includes at least one vent aperture positioned between about 8 inches and about 20 inches from the base, and still more preferably each of the vents includes at least one vent aperture positioned between about 12 inches and about 19 inches from the base.

In one embodiment, the vents are rotary vents.

In one preferred embodiment, the roof is at least about 36 inches from the base, measured from a position where the roof is closest to the base.

### BRIEF DESCRIPTION OF THE DRAWINGS

These and other features will become more apparent from the following description in which reference is made to the appended drawings wherein:

FIG. 1 is a top rear perspective view of a first exemplary animal housing unit;

FIG. 2 is a top front perspective view of the animal housing unit of FIG. 1;

FIG. 3 is a first side elevation view of the animal housing unit of FIG. 1;

FIG. 4 is a rear elevation view of the animal housing unit of FIG. 1;

FIG. 5 is a second side elevation view of the animal housing unit of FIG. 1;

FIG. 6 is a front elevation view of the animal housing unit of FIG. 1;

FIG. 7 is a top plan view of the animal housing unit of FIG. 1;

FIG. 8 is a top rear perspective view of a second exemplary animal housing unit;

FIG. 9 is a top front perspective view of the animal housing unit of FIG. 8;

FIG. 10 is a first side elevation view of the animal housing unit of FIG. 8;

FIG. 11 is a rear elevation view of the animal housing unit of FIG. 8;

FIG. 12 is a second side elevation view of the animal housing unit of FIG. 8;

FIG. 13 is a front elevation view of the animal housing unit of FIG. 8; and

FIG. 14 is a top plan view of the animal housing unit of FIG. 8.

### DETAILED DESCRIPTION

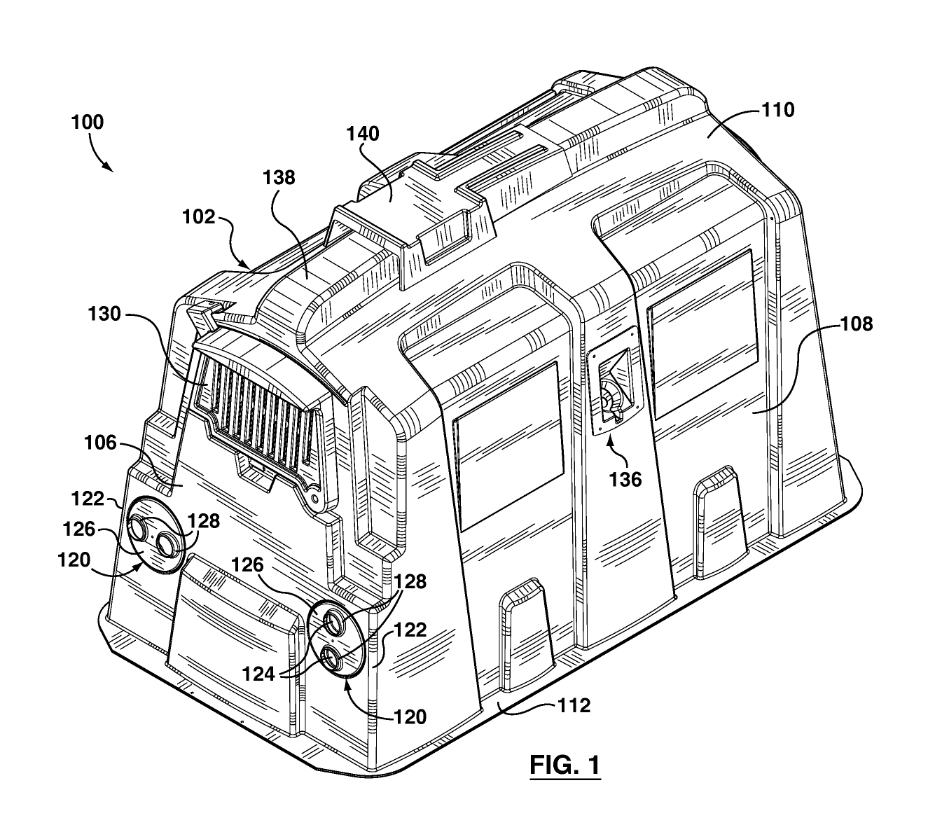

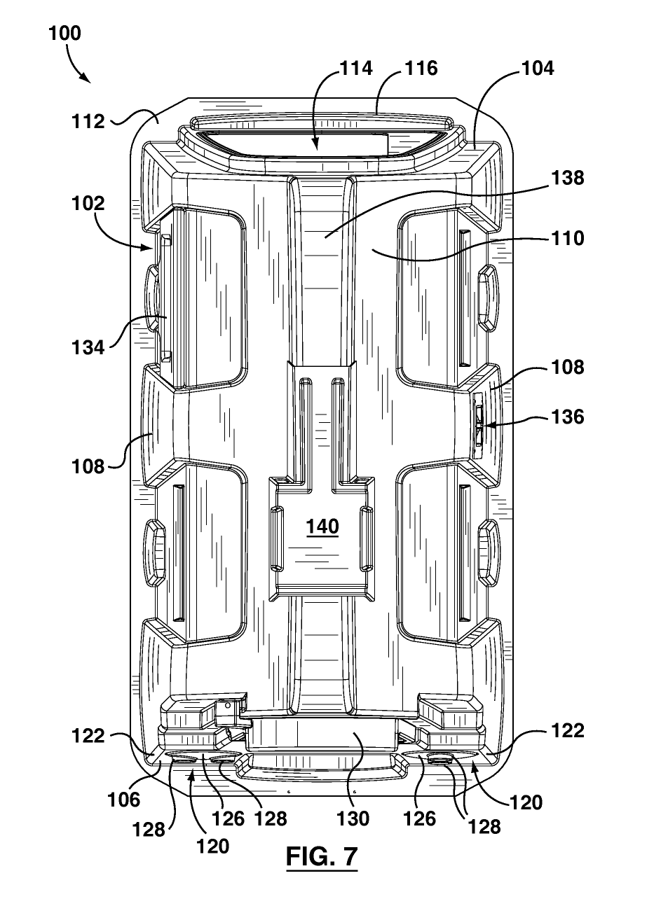

Reference is now made to FIGS. 1 to 7, which show a first exemplary animal housing unit, indicated generally by reference 100. The animal housing unit 100 comprises an enclosure 102 formed from a front wall 104, a rear wall 106 opposed to the front wall 104, two opposed side walls 108 extending between the front wall 104 and the rear wall 106, and a roof 110 spanning the walls 104, 106, 108. The animal housing unit 100 further comprises a base 112 remote from the roof 110 and adapted to support the enclosure 102 on a surface. In the illustrated embodiment, the base 112 takes the form of a peripheral flange 112 extending outwardly from the ends of the walls 104, 106, 108 remote from the roof 110 so as to provide the enclosure 102 with an open bottom. In other embodiments, the enclosure may be provided with a floor, which may form all or part of the base. Preferably, the enclosure 102 is of monolithic construction and is formed by molding.

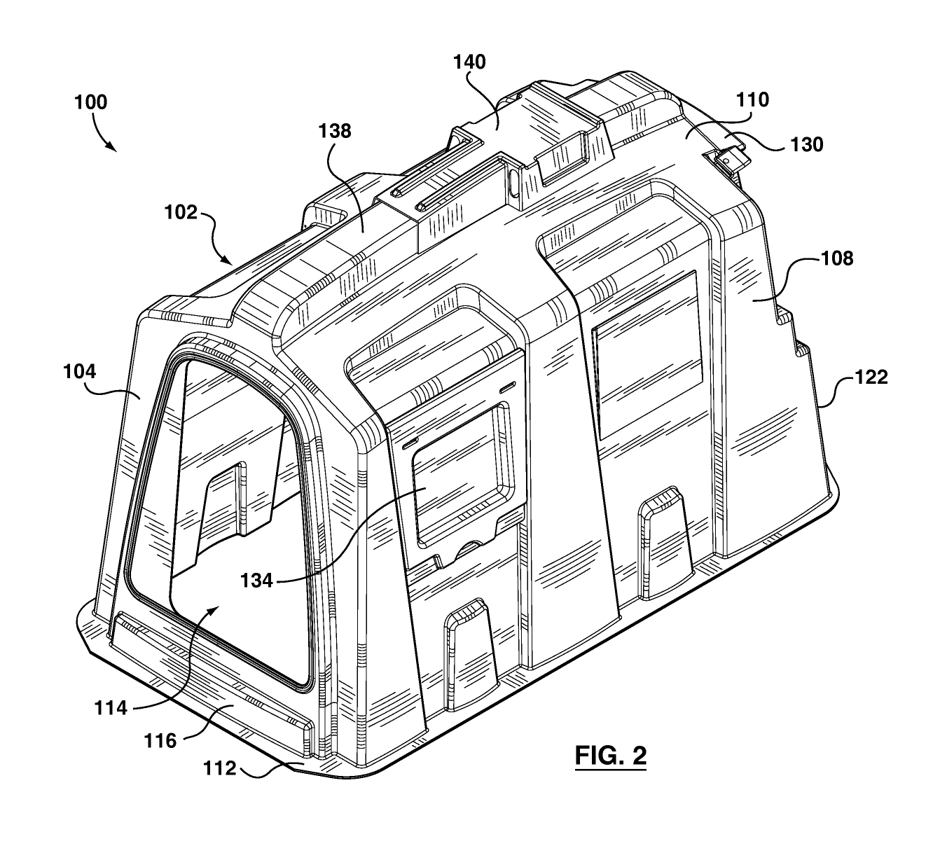

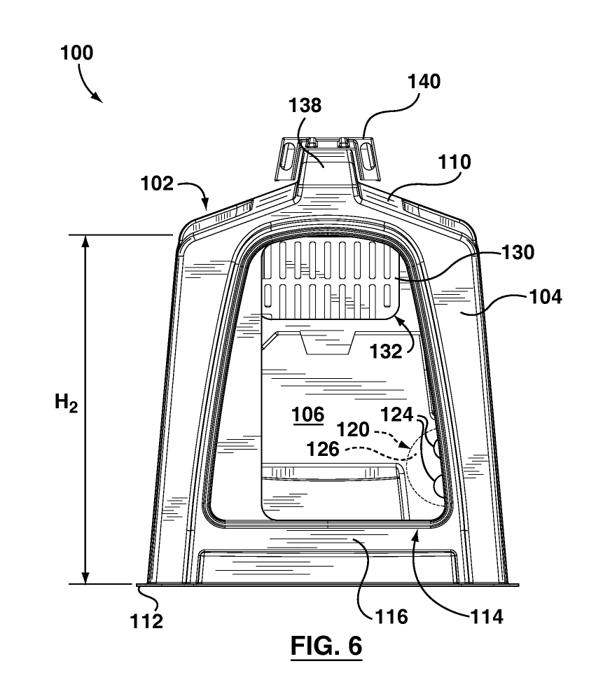

As best seen in FIGS. 2 and 6, a doorway 114 is formed in the front wall 104 to permit ingress of an animal into, and egress of an animal out of, the enclosure 102.

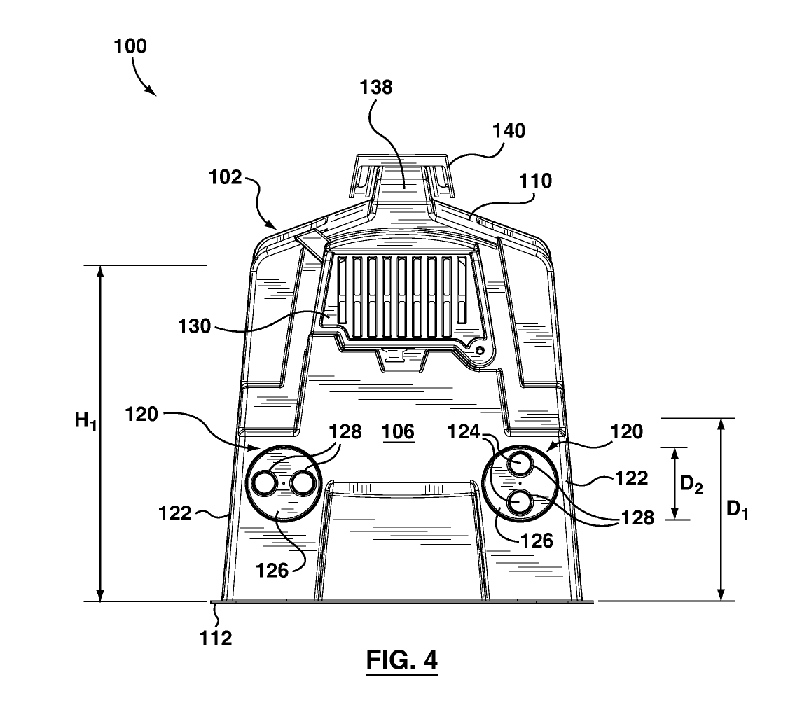

In a preferred embodiment, the animal housing unit 100 is sized for use with bovine calves or goats, and in such embodiments the roof 110 should be at least about 36 inches from the base 112, measured from a position where the roof 110 is closest to the base 112, as shown by line H₁ in FIG. 4, with the doorway 114 being correspondingly dimensioned. In a preferred embodiment, the top of the doorway 114 should be at least about 37 inches from the base 112, as shown by line H₂ in FIG. 6. The doorway 114 may include a raised threshold 116 to increase the strength of the animal housing unit 100 so long as the threshold 116 is low enough for an animal to easily step over when entering or leaving the enclosure 102.

Referring now to FIGS. 1, 4, 6 and 7, two selectively closable vents 120 are formed in the lower portion of the rear wall 106, i.e. the portion of the rear wall 106 that is closer to the base 112 than to the roof 110. The term “selectively closable”, as applied to vents herein, means that the vents are movable between a closed configuration in which airflow through the vent is obstructed and an open configuration in which airflow through the vent is permitted. Selectively closable vents may also include an intermediate configuration, between the open configuration and the closed configuration, to limit airflow therethrough.

The vents 120 are located adjacent respective junctions 122 (best seen in FIGS. 1 and 4) between the rear wall 106 and the side walls 108. In the illustrated embodiments, the vents 120 are rotary vents. The exemplary rotary vents 120 each comprise two vertically aligned vent apertures 124 (best seen in FIG. 6) formed through the rear wall 106 adjacent the respective junction 122, and a closure member 126 with two correspondingly positioned vent ports 128 formed therethrough. The closure member 126 is rotatably mounted on the rear wall 106 with the center of rotation between the vertically aligned vent apertures 124. When the closure member 126 is rotated so that the vent ports 128 are horizontally aligned, as shown on the left side of FIG. 1, the vent ports 128 are out of registration with the vertically aligned vent apertures 124, closing the vent 120 and obstructing airflow. When the closure member 126 is rotated so that the vent ports 128 are vertically aligned, as shown on the right side of FIG. 1, the vent ports 128 are in registration with the vertically aligned vent apertures 124, opening the vent 120 and permitting airflow therethrough. Hence By rotating the closure members 126 to an intermediate position between the position shown on the left side of FIG. 1 and the position shown on the right side of FIG. 1, the vents 120 can be partially opened to limit airflow.

Importantly, for each of the vents 120, the lowermost of the vertically aligned vent apertures 124 (i.e. the vent aperture 124 closest to the base 112), and preferably both vent apertures 124, are positioned less than about 24 inches from the base 112, measured vertically toward the roof 110, as shown schematically by line D₁ in FIG. 4. The vent apertures 124, or at least the lowermost vent apertures 124, are preferably positioned between about 6 inches and about 22 inches from the base 112, more preferably between about 8 inches and about 20 inches from the base 112, and still more preferably between about 12 inches and about 19 inches from the base 112, as shown schematically by line D₂ in FIG. 4. This positioning of the vent apertures 124 can be appreciated from FIG. 4 when considering the animal housing unit 100 as sized for use with bovine calves or goats, for which the roof 110 should be at least about 36 inches from the base 112 as noted above and shown schematically by line H₁ in FIG. 4. Note that lines D₁, D₂, H₁ and H₂ are provided for illustrative purposes only and are not necessarily to scale with one another or with the animal housing unit 100.

As used in reference to vent apertures, the term “positioned” refers to any portion of the vent aperture; hence if any portion of the vent aperture is within the specified distance from the base, the vent aperture is considered to be “positioned” within the specified distance from the base.

The rotary vents shown in FIGS. 1, 4, 6 and 7 are merely exemplary, and one skilled in the art, now informed by the present disclosure, will appreciate that different types of rotary vents, or other types of selectively closable vents, may equivalently be used in the lower portion of the rear wall adjacent the junctions between the rear wall and the side walls so long as the vents include at least one vent aperture positioned less than about 24 inches from the base. For example, vents may be used wherein the closure member slides, rather than rotates, to move the vent ports into and out of registration with the vent apertures. Moreover, while the exemplary embodiment shown herein has one vent 120 in the lower portion of the rear wall 106 adjacent each junction 122 (FIGS. 1 and 4) between the rear wall 106 and a respective side wall 108, other embodiments may include two or more vents in the lower portion of the rear wall adjacent each such junction.

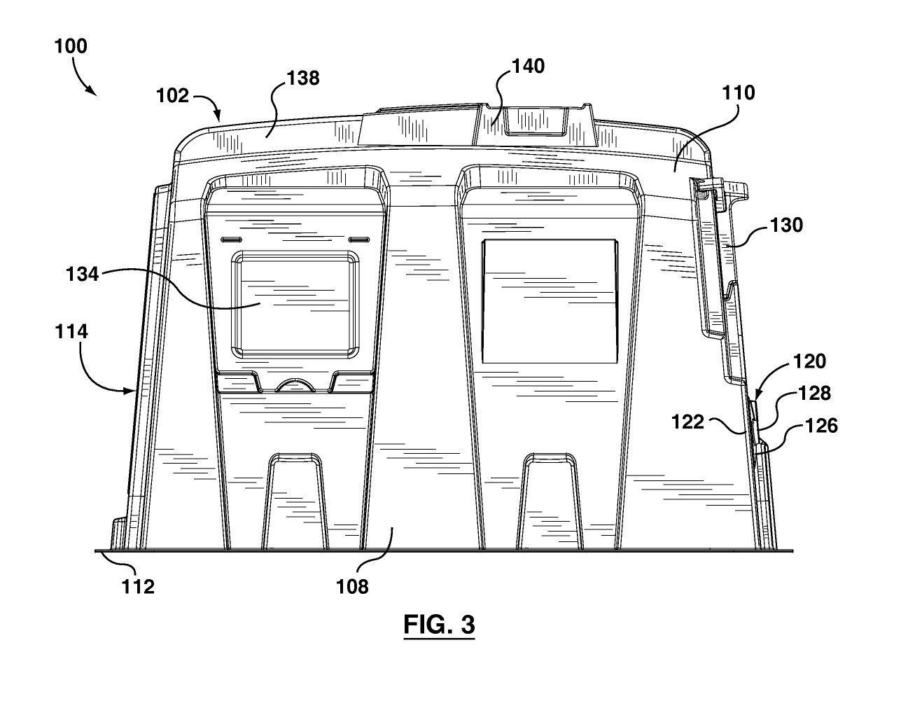

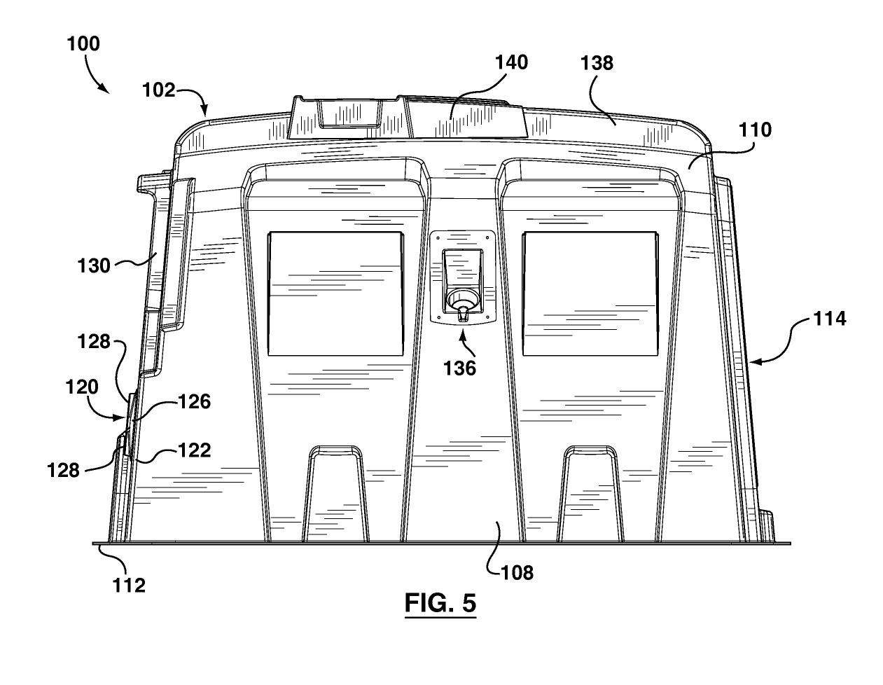

The first exemplary animal housing unit 100 includes a rear feed door 130 incorporating a sliding vent, with the rear feed door 130 being pivotally mounted on the rear wall 106 in registration with a rear feed opening 132 therethrough (see FIG. 6). Referring to FIGS. 2 and 3, the first exemplary animal housing unit 100 also includes a side feed door 134 for accessing a side feed opening (not shown) in one of the side walls 108. As best seen in FIGS. 1 and 5, a bottle receptacle 136 is incorporated into one of the side walls 108. The first exemplary animal housing unit 100 has a roof vent taking the form of a plurality of roof vent apertures (not shown) formed in a central roof ridge 138 extending along the roof 110 between the front wall 104 and the rear wall 106, and a closure member 140 slidably received on the central roof ridge 138. Other types of roof vents may also be used.

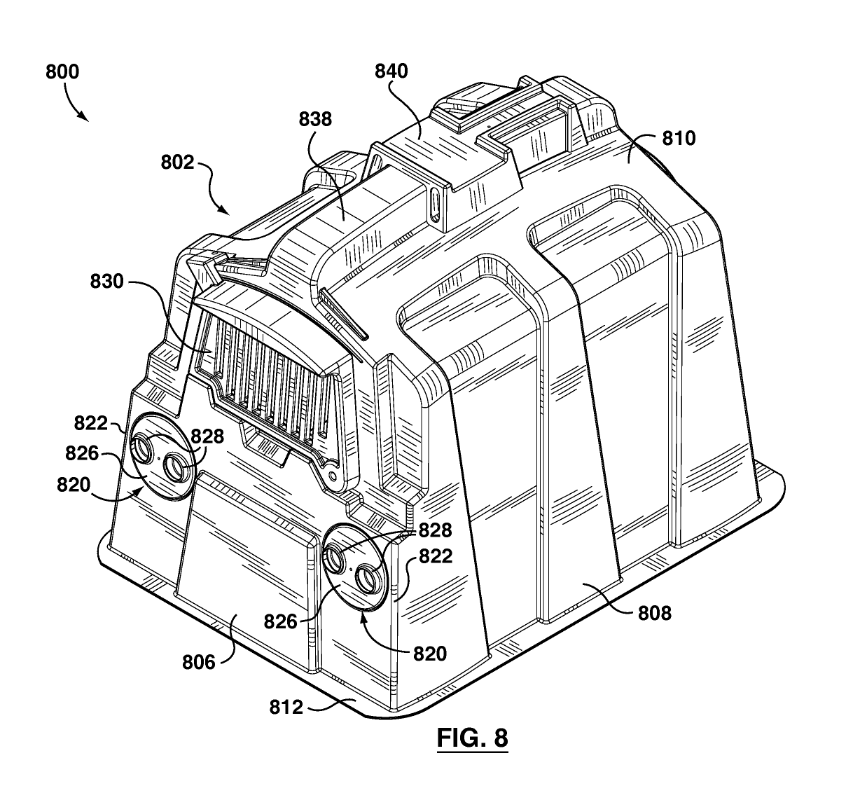

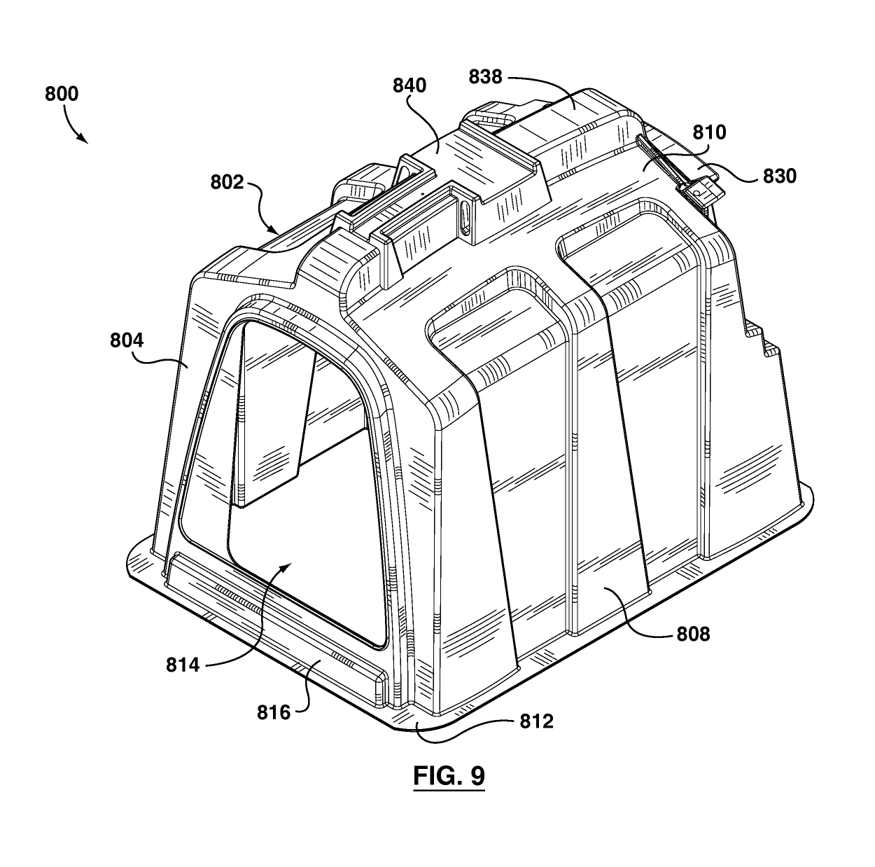

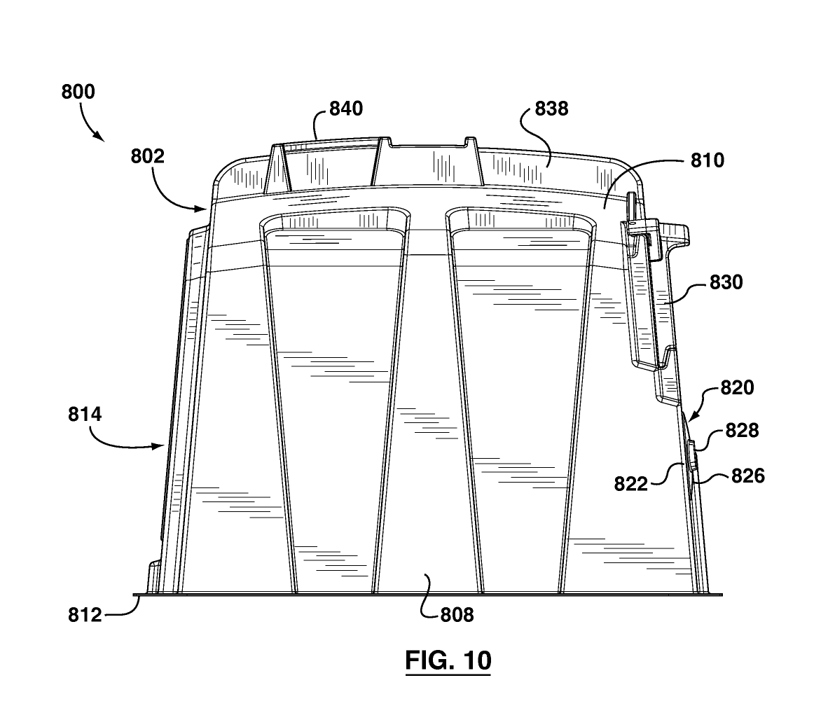

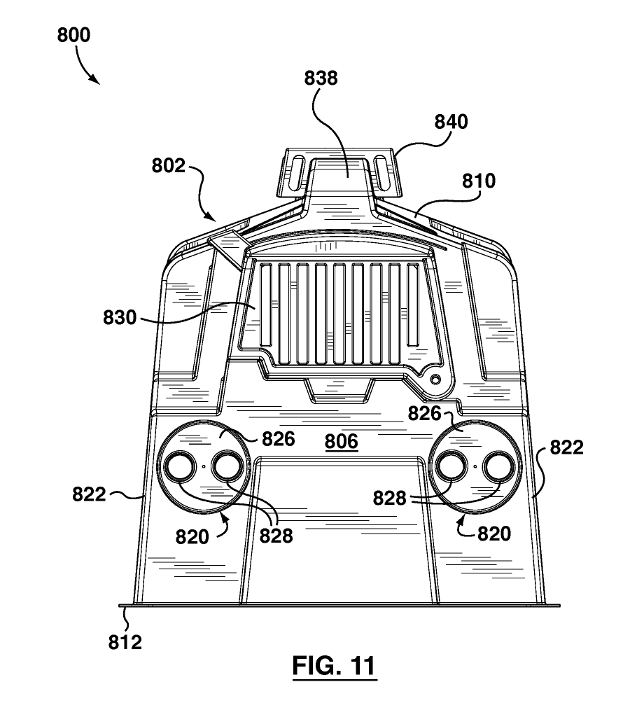

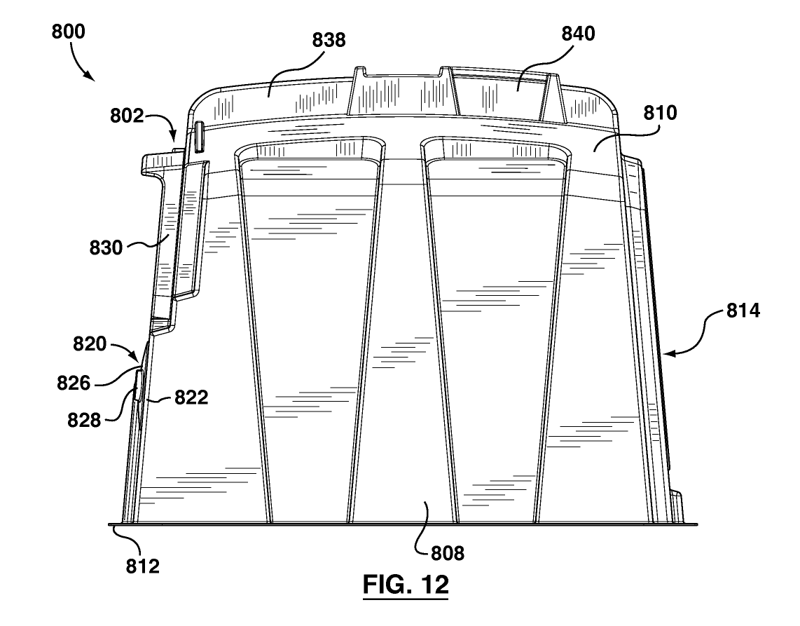

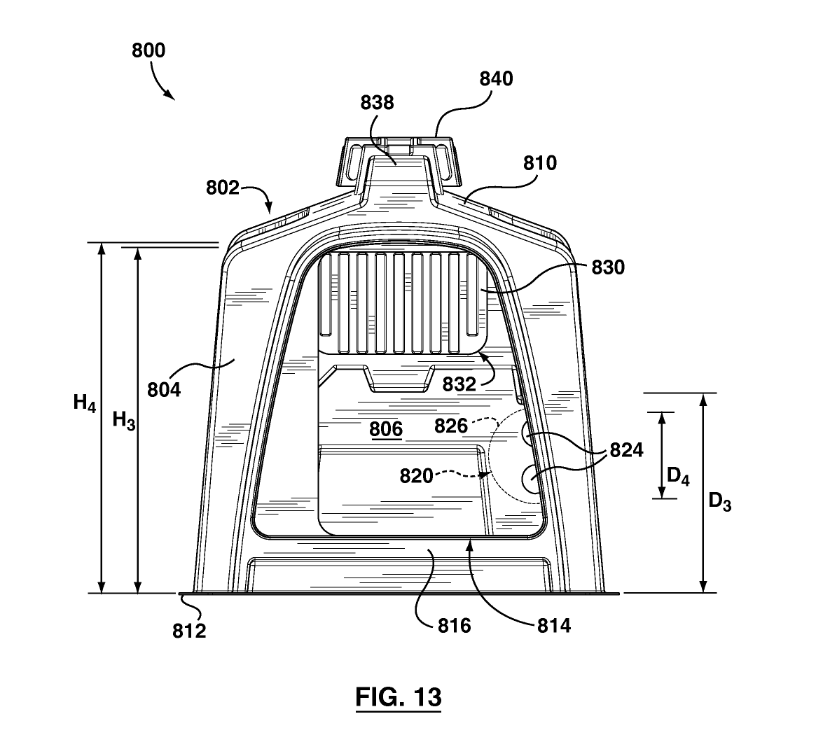

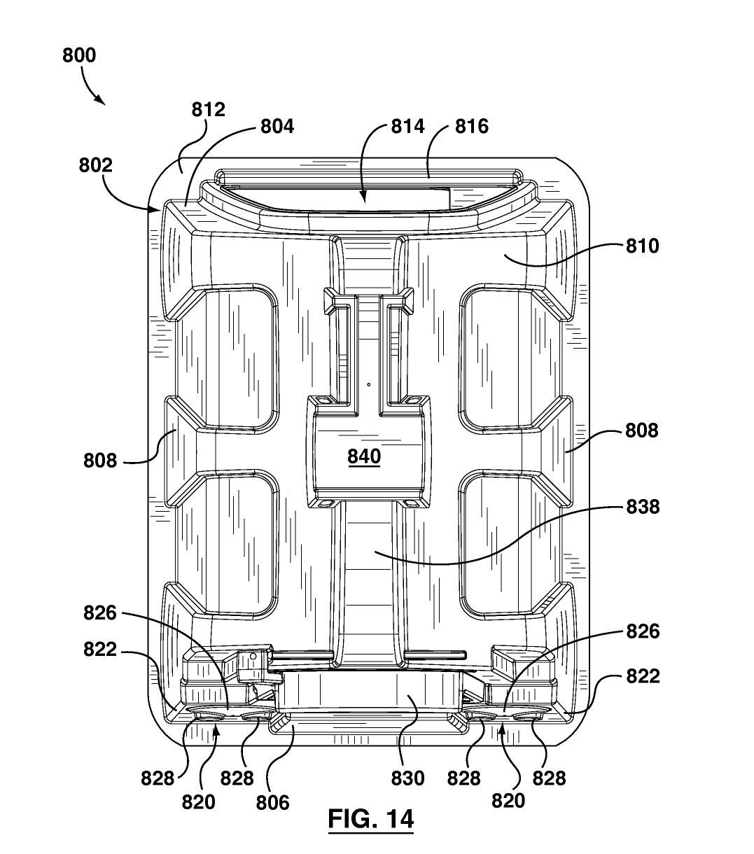

FIGS. 8 to 14 show a second exemplary animal housing unit 800 which is similar to the first exemplary animal housing unit 100, with like reference numerals denoting like features except with the prefix “8” instead of “1”. The second exemplary animal housing unit 800 differs from the first exemplary animal housing unit 100 in that the second exemplary animal housing unit 800 does not include a rear feed door/aperture, side feed door/aperture or bottle receptacle. Although the second exemplary animal housing unit 800 is smaller than the first exemplary animal housing unit 100, the roof 810 of the second exemplary animal housing unit 800 is at least about 36 inches from the base 812, measured from a position where the roof 810 is closest to the base 812, shown schematically by line H₃ in FIG. 13, and the top of the doorway 814 is at least about 37 inches from the base 812, shown schematically by line H₄ in FIG. 13.

Like the first exemplary animal housing unit 100, the second exemplary animal housing unit 800 includes two selectively closable rotary vents 820 (see FIGS. 8, 11, 13 and 14) in the lower portion of the rear wall 806 adjacent respective junctions 822 (best seen in FIGS. 8 and 13) between the rear wall 806 and the side walls 808. As with the first exemplary animal housing unit 100, in the second exemplary animal housing unit 800 the lowermost of the vertically aligned vent apertures 824, and preferably both vent apertures 824, are positioned less than about 24 inches from the base 812 (shown by line D₃ in FIG. 13), preferably between about 6 inches and about 22 inches from the base 812, more preferably between about 8 inches and about 20 inches from the base 812, and still more preferably between about 12 inches and about 19 inches from the base 812 (shown by line D₄ in FIG. 13).

Lines D₃, D₄, H₃ and H₄ are provided for illustrative purposes only and are not necessarily to scale with one another or with the animal housing unit 800.

Certain currently preferred embodiments have been described by way of example. It will be apparent to persons skilled in the art that a number of variations and modifications can be made without departing from the scope of the claims.

What is claimed is:

1. An animal housing unit, comprising:
an enclosure, the enclosure comprising:
a front wall;
a rear wall opposed to the front wall;
two opposed side walls extending between the front wall and the rear wall; and
a roof spanning the walls;
a base remote from the roof and adapted to support the enclosure on a surface;
a doorway formed in the front wall;
at least two selectively closable vents in the rear wall adjacent respective junctions between the rear wall and the side walls;
wherein each of the vents includes at least one vent aperture positioned less than about 24 inches from the base.

2. The animal housing unit of claim 1, wherein each of the vents includes at least one vent aperture positioned between about 6 inches and about 22 inches from the base.

3. The animal housing unit of claim 2, wherein each of the vents includes at least one vent aperture positioned between about 8 inches and about 20 inches from the base.

4. The animal housing unit of claim 3, wherein each of the vents includes at least one vent aperture positioned between about 12 inches and about 19 inches from the base.

5. The animal housing unit of claim 1, wherein the at least two vents are rotary vents.

6. The animal housing unit of claim 1, wherein the roof is at least about 36 inches from the base, measured from a position where the roof is closest to the base.
